(19) United States
(12) Patent Application Publication
(10) Pub. No.: US 2009/0145242 A1
(43) Pub. Date: Jun. 11, 2009

(54) Apparatus for Measuring Stresses on Rotating Blades and Methods Thereof

(75) Inventors: Ernest B. Pryor, JR., Maidens, VA (US); Adam Hanes, Glen Allen, VA (US); Ben H. Branson, III, Mechanicsville, VA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: HAMILTON BEACH BRANDS, INC., Glen Allen, VA (US)

(21) Appl. No.: 11/954,005

(22) Filed: Dec. 11, 2007

(51) Int. Cl. G01N 3/02; G01L 1/00

(52) U.S. Cl. 73/856; 702/42

(57) ABSTRACT

A strain gauge apparatus for measuring stresses on a rotating blade includes a strain gauge assembly, a shaft connectable to the rotating blade, a slip ring connected to the shaft, and a sleeve for covering lead wires routed along the shaft from the strain gauge and connected to the slip ring. The present invention also relates to a method of determining the fatigue life of a rotating blade.

### BACKGROUND OF THE INVENTION

The present invention generally relates to a strain gauge assembly for rotating blades. In particular, the present invention is related to a strain gauge apparatus for measuring stresses and strains on rotating blades, a method thereof, a method of determining the fatigue life of a rotating blade, and a method of evaluating rotating blades as an acceptance criteria.

Rotating blades, such as high speed rotating blades, exhibit high rotational forces and as a result are exposed to various stresses under actual use conditions. For example, blenders having a rotating blender blade are typically used to blend or mix various substances, typically foods, liquids, and even ice; the mixing of ice being one of the most extreme operating conditions for blender blades. As a result, such blender blades are prone to fatigue failure over prolonged use.

Rotating blades are typically made of materials, such as steel, sufficient to withstand extreme operating conditions, such as high shear and impact forces. As a result, due to the extreme operating conditions often associated with rotating blades, its is difficult to evaluate or measure the stresses on rotating blades during normal or extreme operating conditions. In addition, measuring stresses and strains on rotating blades during actual use is difficult because of the rotational speeds encountered by the rotating blades and the harsh environment within which rotating blades often operate, neither of which is conducive to the use of conventional measuring instruments or techniques. Under the typical operating conditions of rotating blades, measuring instruments such as strain gauges may be physically compromised or damaged as a result of the rotating blades operating environment and may even short due to the conductivity of fluids that may be in contact with such rotating blades, for example as in the mixing of drinks associated with rotating blender blades. As a result, it is difficult to evaluate or determine the operating life or fatigue life of any particular rotating blade design or to develop any acceptance criteria associated with fatigue failure for use in the manufacturing of rotating blades.

Accordingly, there is still a need for a strain gauge apparatus for measuring stresses on rotating blades, a method of evaluating the fatigue life of rotating blades, and a method for evaluating a rotating blade such that one can determine whether or not such a rotating blade meets a minimal manufacturing or other acceptance criteria.

### BRIEF SUMMARY OF THE INVENTION

In an embodiment, the present invention provides for a strain gauge apparatus for measuring stresses on a rotating blade comprising: a strain gauge assembly that includes: a strain gauge for measuring strain on a rotating blade, and lead wires connected to the strain gauge; a shaft connected to the rotating blade; and a slip ring connected to the shaft and the lead wires.

In another embodiment, the present invention provides for a strain gauge apparatus for measuring stresses on a blender blade mounted within a blender, comprising: a strain gauge secured to a blender blade; a shaft connected to the blender blade and extending through an upper portion of the blender; lead wires connected to the strain gauge and routed along the shaft; and a slip ring connected to the lead wires and the shaft at the upper portion of the blender.

In yet another embodiment, the present invention provides for a method of measuring stresses on a rotating blade comprising the steps of: securing a strain gauge having lead wires on a rotating blade mounted to a blade shaft; connecting a shaft to the blade shaft for rotation therewith; connecting a slip ring having slip ring wires to the shaft; routing the lead wires along the shaft and connecting the lead wires to the slip ring; and connecting the slip ring wires to a data acquisition system.

In a further embodiment, the present invention provides for a method of determining the fatigue life of a rotating blade comprising the steps of: obtaining raw stress data on a rotating blade under actual use conditions; converting the raw stress data into a first data set; obtaining simulated stress data on the rotating blade under simulated use conditions; converting the simulated stress data into a second data set; and evaluating the first and second data sets to determine the fatigue life of the rotating blade.

In another embodiment, the present invention provides for a method of evaluating rotating blades comprising the steps of: obtaining raw stress data on a rotating blade under actual use conditions; converting the raw stress data into a first data set; obtaining simulated stress data on the rotating blade under simulated use conditions; converting the simulated stress data into a second data set; evaluating the first and second data sets to determine the fatigue life of the rotating blade; and comparing the fatigue life to a predetermined fatigue life value.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments of the invention that are presently preferred. It should be understood, however, that the invention is not limited to the precise arrangements and instrumentalities shown. In the drawings:

FIG. 1 is a front perspective view of a conventional electric blender;

FIG. 2 is a perspective view of a blender blade of the conventional electric blender shown in FIG. 1;

FIG. 3 is a front perspective view of a strain gauge apparatus mounted to a blender for measuring strain of a blender blade in accordance with a preferred embodiment of the present invention;

FIG. 4 is a magnified front perspective view of the strain gauge apparatus of FIG. 3 with portions of the blender removed for clarity;

FIG. 5 is greatly enlarged front perspective view of a strain gauge of the strain gauge apparatus shown in FIG. 4 mounted to a blender blade of the blender shown in FIG. 3;

FIG. 6 is another embodiment of the strain gauge apparatus of FIG. 4 as applied to a food processor;

FIG. 7 is a flow chart of another embodiment of the present invention;

FIG. 8 is a flow chart of yet another embodiment of the present invention;

FIG. 9 is a flow chart of yet a further embodiment of the present invention;

FIG. 10 illustrates a blade fatigue testing apparatus applicable to the present invention;

FIG. 11 is a Stress v. Number of cycles curve for Blender Blade X of Example I;

FIG. 12 is the Raw time history stress data for Blender Blade X of Example I;

FIG. 13 is a Rainflow histogram of alternating stress cycles measured on Blender Blade X of Example I;

FIG. 14 is a Stress v. Number of cycles curve for Blender Blade Y of Example II;

FIG. 15 is the Raw time history data for Blender Blade Y of Example II; and

FIG. 16 is a Rainflow histogram of alternating stress cycles measured on Blender Blade Y of Example II.

### DETAILED DESCRIPTION OF THE INVENTION

Certain terminology is used in the following description for convenience only and is not limiting. The words, “right,” “left,” “lower,” and “upper” designate directions in the drawings to which reference is made. The words, “inwardly” and “outwardly” refer to directions toward and away from, respectively, the geometric center of parts. The terminology includes the words above specifically mentioned, derivatives thereof, and words of similar import. Additionally, the word “a” as used in this specification means at least one.

In an embodiment, the present invention relates to a strain gauge apparatus for measuring stresses on a rotating blade. A rotating blade can be any blade configured to rotate about an axis such as for example, a blender blade, a food processing blade, a mixing blade, a turbine blade, a propeller blade, a cutting blade, a lawn mower blade, a fan blade, and the like. By way of example only and not by way of limitation, the strain gauge apparatus for measuring stresses on a rotating blade will now be described as applied to a rotating blender blade. It is to be understood that the present strain gauge apparatus can be applied to a variety of blades that rotate (i.e., rotating blades). Moreover, although the present embodiment will now be described with regard to a strain gauge, it is contemplated that any other gauge or apparatus capable of measuring stresses, strain, or fatigue that are currently known or to be developed is within the scope of the present invention.

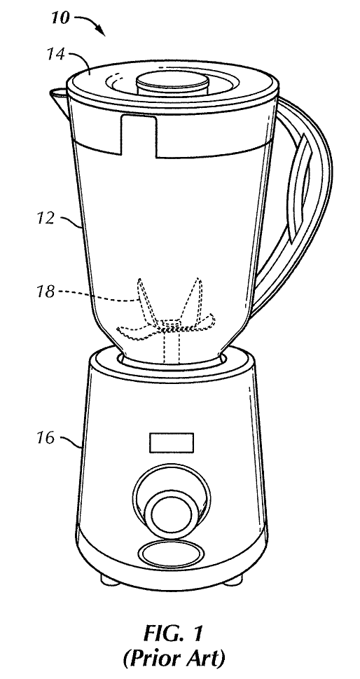

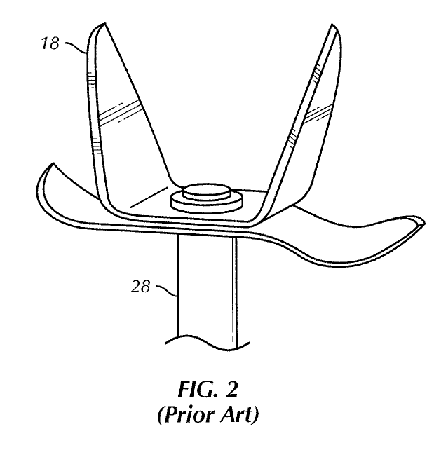

Referring to FIGS. 1 and 2, a conventional electric blender, generally designated 10, includes a blender jar 12, a lid 14, and a base 16. The blender jar 12 is configured with a blender blade 18 (i.e., a rotating blade) at the bottom of the blender jar 12. The base 16 houses an electric motor (not shown) which drives the blender blade 18 when the blender jar 12 is assembled with the base 16. The blender blade 18 is mounted to a blender blade shaft 28, which is in turn driven by the motor to rotate the blender blade 18 and blend foodstuff within the jar 12.

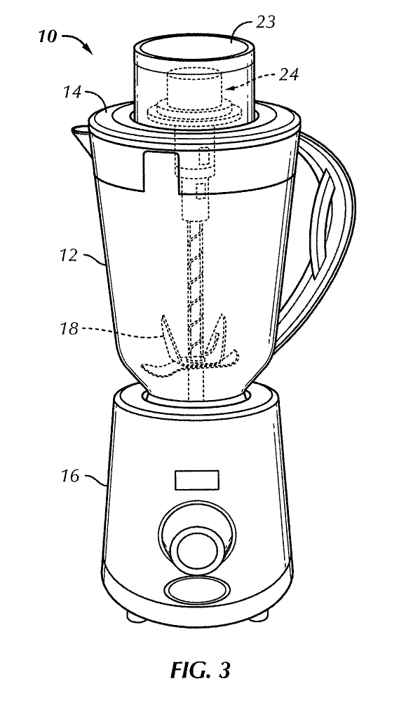

Referring to FIGS. 3-5, a preferred strain gauge apparatus 20 of the present embodiment includes a strain gauge assembly 30, a shaft 22, a slip ring 24, and a sleeve 26 surrounding the shaft 22. The strain gauge assembly 30 includes a strain gauge 32 and a pair of lead wires 34 (only one wire shown for convenience) that extend from the strain gauge 32. The lead wires 34 transmit electrical signals generated by the strain gauge 32. Strain gauges, which are typically used to measure stresses, are well known in the art and a detailed explanation of the structure and operation of such strain gauges is not necessary for a complete understanding of the invention. However, exemplary strain gauges include foil strain gauges, semiconductor strain gauges, gauges attached to load cells, and the like.

Strain gauges are used to measure deformation (strain) of an object. For example, with a foil strain gauge, the strain gauge is attached to an object and strain is measured as the object is deformed. As the object deforms, the foil deforms causing its electrical resistance to change. An optional Wheatstone bridge 33 can also be use to detect and/or amplify the voltage change associated with the change in electrical resistance.

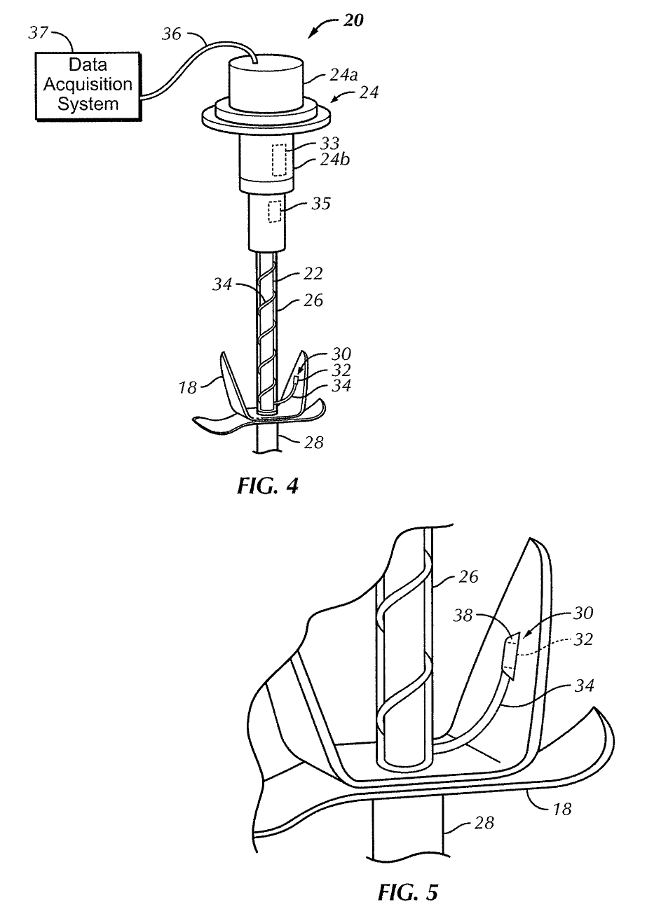

As shown in FIG. 4, the strain gauge 32 can optionally include a Wheatstone bridge 33 and an amplifier 35 to increase the signal strength and decrease the noise measured by the strain gauge 32. The Wheatstone bridge 33 and amplifier 35 advantageously reduces the potential for interference of the strain gauge 32 signal due to electromagnetic fields or other electrical interference that may be encountered in a typical blender testing environment.

Referring back to FIG. 4, the shaft 22 is configured to be connectable to a blender blade 18 and blender blade shaft 28 and rotates with the blender blade shaft 28 and blender blade 18 during use. The shaft 22 is preferably connected to the blender blade shaft 28 by mating male and female threads (not shown). For example, the shaft 22 can be configured with external (male) threads and the blender blade shaft 28 configured with corresponding internal (female) threads. Alternatively, the shaft 22 can be connected to the blender blade shaft 28 by any other connection sufficient to securely mount the shaft 22 to the blender blade shaft 28 such that the shaft 22 rotates with the blender blade shaft 28. Such connections can include a bayonet connection, a quick connect, a snap fit, a taper lock, or any other connection sufficient for its intended use.

The shaft 22 can be a longitudinal member and can be of any configuration suitable for its intended use. For example, the shaft 22 can be a small diameter circular cross-sectional shaft, of a square or hexagonal cross-section or of any cross-sectional configuration that is able to withstand the typical operating conditions encountered by the shaft 22. The shaft 22 preferably has a length sufficient to extend from the connection with the blender blade shaft 28 and blender blade 18 to a connection with the slip ring 24. The shaft 22 which is preferably made of steel, can be constructed of any material suitable for its intended purpose, such as a metal, a polymeric material, or a composite material.

The slip ring 24 can be any conventional type of slip ring that allows for the transmission of power and/or electrical signals between a stationary part and a rotating part. Slip rings are generally well known in the art and a detailed explanation of the structure and operation of slip rings is not necessary for a complete understanding of the present application. However, exemplary slip rings include slip rings with through-bores, slip ring capsules, high speed slip ring capsules, large diameter slip rings, fiber optic rotary joints, poly-twist or twist capsules, vehicular slip rings, and the like. Typical slip rings include a conductive circle or band mounted on a shaft and insulated from it. Electrical connections from the rotating part of a system are made to the ring. Fixed contacts or brushes run in contact with the ring, transferring electrical power and/or signals to the exterior, static part of the system.

In the present embodiment, as shown in FIG. 4, the slip ring 24 includes a stationary portion 24a and a rotating portion 24b. In a preferred embodiment, the slip ring 24 also includes a Wheatstone bridge 33 and an amplifier 35 mounted to the rotating portion 24b. The Wheatstone bridge 33 and the amplifier 35 helps to improve the quality of data that is transmitted to a data acquisition system 37. A pair of slip ring wires 36 (only one shown for convenience) transmits electrical signals outputted from the slip ring 24 to the data acquisition system 37. The data acquisition system 37 can be for example a computer, a programmable logic controller, or any other device sufficient for its intended use readily known in the art.

Referring to FIG. 3, the slip ring 24 can be mounted to the lid 14 by a mounting structure 23. The mounting structure 23 is preferably constructed of a rigid material that is able to mount to the conventional lid 14 and is capable of engaging the stationary portion 24a of the slip ring 24 to secure the slip ring 24, shaft 22 and lead wires 34 relative to the blender 10 during testing and operation. The mounting structure 23 can be constructed to mount in a conventional blender lid feed hole (not shown) or the lid 14 may be specifically adapted for mounting the mounting structure 23 thereon. The mounting structure 23 is not limited to rigid, polymeric constructions and may be constructed of nearly any generally rigid, structural material that is able to take on the general shape of the mounting structure 23, withstand the normal operating conditions of the mounting structure 23 and secure the slip ring 24 relative to the blender 10. In addition, the mounting structure 23 is not limited to being mounted to the lid 14 and may be mounted directly to the jar 12 or nearly any other structure, such as a test fixture that is generally stationary relative to the blender 10 during testing. However, the mounting structure 23 is preferably mounted to the lid 14 such that the blending environment within the jar 12 is generally replicated in comparison to typical blending conditions and flow patterns within the jar 14 such that the stresses and strains encountered by the blender blade 18 are similar to those encountered in normal use.

Referring to FIGS. 4 and 5, the sleeve or cover 26 serves to cover the lead wires 34 routed along the shaft 22. The sleeve 26 can be a flexible material (e.g., plastic wrap, elastomer, foil, etc.) wrapped around the shaft 22 and/or lead wires 34 or may be constructed as a rigid shaft that generally creates a hollow space along the shaft 22 that is free of fluid. An exemplary sleeve 26 can be an annular sleeve with an internal diameter slightly larger than the maximum cross-sectional thickness of the shaft 22 and lead wires 34. The sleeve 26 is preferably configured to rotate in sync with the shaft 22. However, the sleeve 26 can also be configured not to rotate with the shaft 22 or rotate at a different rate than the shaft 22. The sleeve 26 provides for a covering for the lead wires 34 and the shaft 22 and can further provide a waterproof covering for the lead wires 34. This advantageously reduces the potential that current may flow from the lead wires 34 into fluids being utilized in the blender 10 for testing, thereby contaminating any results of the testing, for example, by creating a short between the lead wires 34 anywhere along their length. In another embodiment, the sleeve 26 can be configured to cover primarily the lead wires 34 routed along the shaft 22, such as a lead wire flexible wrap.

The sleeve 26 can be constructed from a metal, a composite, a polymeric material, or nearly any other material that is able to take on the general shape of the sleeve 26, perform the preferred functions of the sleeve 26 and withstand the typical operating conditions encountered by the sleeve 26. Preferably the sleeve 26 is constructed from a polymeric material such as an epoxy material, a shrink wrap (e.g., a polyvinyl chloride based plastic film), or any other waterproofing film.

The strain gauge apparatus 20 can also include a data acquisition system 37, such as a computer or programmable logic controller to measure, acquire, and/or record data measured by the strain gauge assembly 30. The data acquisition system 37 can also be configured (such as with various software programs, e.g., GlyphWorks by nCcode) to analyze the data.

In operation, the strain gauge apparatus 20 is instrumented to a blender blade 18. That is, the strain gauge apparatus 20 is connected to a blender blade shaft 28 via the shaft 22. The strain gauge 32 is secured to the blender blade 18 with an adhesive or other adhering mechanisms (e.g., a bonding agent or gauge clamp) that secures the strain gauge 32 to the blender blade 18 such that the strain gauge 32 can deform as the blender blade 18 bends, deflects, or is deformed during use. Strain gauges 32 and their method of attachment to various surfaces are well known in the art and a detailed description of the various methods of attachment used for conventional strain gauges is not necessary for a complete understanding of the present invention. Preferably, the strain gauge 32 is adhered to the blender blade 18 in the area of highest anticipated stresses based on engineering principles such as finite element analysis, failure mode analysis, or the like and is also preferably mounted at a location on the blade 18 where potential impacts from debris, such as ice chunks, is low to reduce the potential for debris to delaminate or otherwise affect the strain gauge 32 or damage/disconnect the lead wires 34. The strain gauge 32 is not limited to being connected to the blender blade 18 at the anticipated highest stress locations and may be positioned on the blade 18 at a location wherein contact with debris in the blending foodstuff is expected to be low, at a location wherein failure of the blender blade 18 is anticipated or nearly anywhere along the blender blade 18 where stresses and strains may be monitored during use and testing.

The lead wires 34 are preferably wrapped around the length of the shaft 22 and connected to the rotating portion 24b of the slip ring 24. Preferably, the lead wires 34 are routed along the shaft 22 in a coil fashion. The sleeve 26 can be placed or applied over the shaft 22 and lead wires 34 to secure the lead wires 34 in position and protect the lead wires 34 from the harsh blending environment within the blender 10. This configuration advantageously protects the strain gauge assembly 30 from the operating conditions within the blender 10, such as when it is desirable to obtain stress data at very high revolutions per minute (RPM) such as around 20,000 RPMs. In addition, the lead wires 34 are preferably wrapped around the shaft 22 such that any torsional deflection of the shaft 22 generally results in the lead wires 34 loosening from the shaft 22, as opposed to tightening around the shaft 22 and potentially damaging the lead wires 34 or the attachment of the lead wires 34 to the strain gauge 32. For example, if the blender blade 18 impacts a large piece of ice during testing and the shaft 22 is subjected to a torsional deflection, the lead wires 34 preferably would have a tendency to loosen from the shaft 22 to compensate for the torsional deflection.

The strain gauge 32 is preferably adhered to the blender blade 18 and covered with a coating 38 such as an epoxy, as is shown in FIG. 5. The coating 38 (e.g., an epoxy) advantageously provides protection to the strain gauge 32 during the operating conditions within the blender 10. The coating 38 also provides waterproofing for the strain gauge 32 and/or the lead wires 34, because the blender blade 18 and strain gauge apparatus 20 are typically subjected to fluids during testing, which may have an adverse impact on the operation and/or function of the strain gauge 38, lead wires 34, and the overall strain gauge apparatus 20. For example, without the preferred coating 38 there is a potential that current may flow from the strain gauge 32 into the fluid surrounding the strain gauge 32 during testing, thereby contaminating the test results by creating a short at the strain gauge 32. However, the coating 38 is not limited to being included in the strain gauge apparatus 20 and is not specifically limited to epoxies that provide waterproofing properties and may be constructed of nearly any material that is able to cover or provide protection or adhesive/mounting properties for the benefit of the lead wires 34 and/or strain gauge 32. Exemplary coatings include GageKote, M-Bond, M-Coat, and RTV coatings, all of which are available from Vishay Intertechnology Inc. of Malvern, Pa.

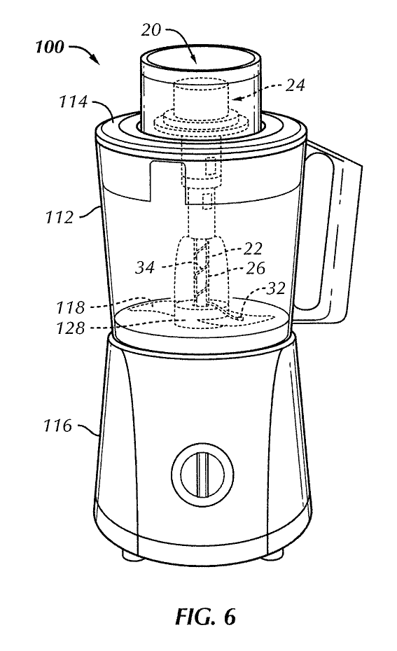

FIG. 6 illustrates the strain gauge apparatus 20 of the present embodiment as applied to a food processing blade 118 of a food processor 100. The strain gauge apparatus 20 can be configured with the food processor 100 similarly to that of the electric blender 10 embodiment above. The food processor 100 can be any conventional food processor which includes a food processing jar 112, a lid 114, and a base 116. The base 116 houses an electric motor (not shown) which drives the food processing blade 118 when the food processing jar 112 is assembled to the base 116. The food processing blade 118 is mounted to a food processing blade shaft 128, which is in turn driven by the motor to rotate the food processing blade 118 to process foods.

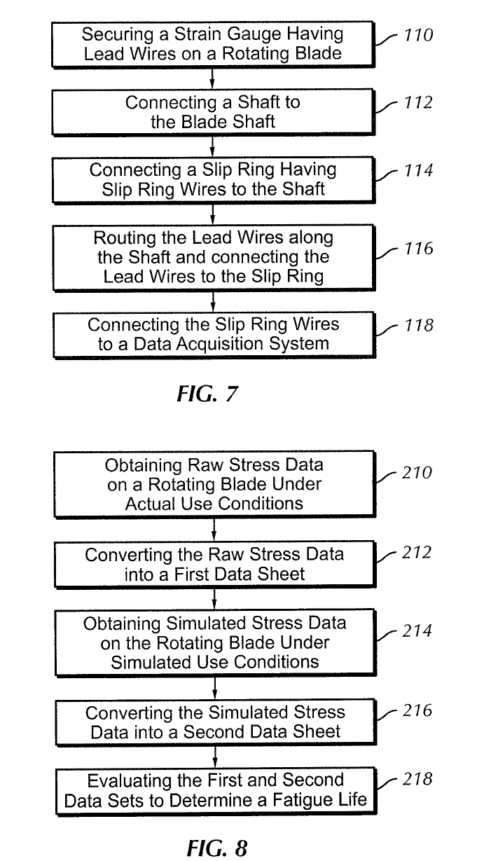

The present invention also provides for a method of measuring stresses on a rotating blade as shown in the flow chart of FIG. 7. In practicing this method, a strain gauge 32 having lead wires 34 is secured on a rotating blade mounted to a blade shaft 28 (step 110) and a shaft 22 is connected to the blade shaft 28 (step 112). The shaft 22 is preferably connected to the blade shaft 28 such that the shaft 22 and the blade shaft 28 are substantially co-axial and rotate together. A slip ring 24 having slip ring wires 36 is connected to the unmounted end of the shaft 22 (step 114). The strain gauge lead wires 34 are routed along the shaft 22 and connected to the slip ring 24 (step 116). The slip ring wires 36 are then connected to a data acquisition system 37 (e.g., a computer) to measure and/or record stress data as the rotating blade is operated (step 118). The method can further include the step of covering the strain gauge 32 with a coating 38 such as for example, an epoxy. The method can also include the step of covering the lead wires 34 routed along the shaft 22. The cover can be a sleeve 26 as described in the above embodiments.

The present invention further provides for a method of determining the fatigue life of a rotating blade as shown in FIG. 8. The term “fatigue life” or “fatigue failure” as it is commonly understood refers to the number of fatigue cycles a component part can withstand before strutural damage such as fracturing or breaking occurs. In general, “fatigue” is the progressive and localized structural damage that occurs when a material is subject to cyclic loading. In this embodiment, raw stress data on the rotating blade is obtained under actual use conditions (step 210). In measuring the stresses on the rotating blade, the strain gauge apparatus 20 as described above is used to measure stresses on the rotating blade under actual use conditions. The raw stress data is typically measured in ksi (i.e., MPa) versus time (i.e., seconds). The raw stress data is then converted into a first data set (step 212). The raw data set is converted by first reducing the raw data set into a rainflow histogram. This can be accomplished with computer software, such as GlyphWorks software by nCode or by numerical methods. The non-zero mean stresses of the rainflow histogram is then normalized to an equivalent zero mean stress data set. Thereafter, the equivalent zero mean stress data set is grouped into counts for common normalized zero mean stress data ranges.

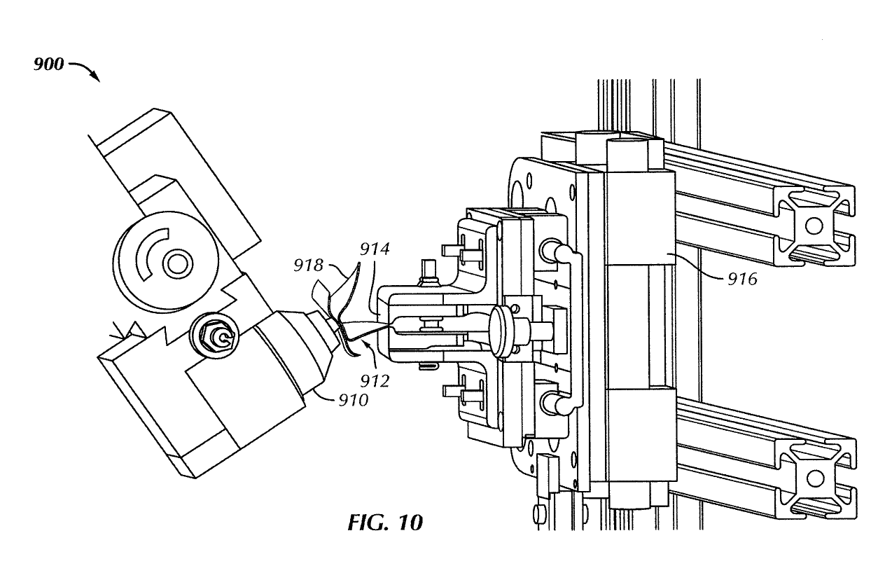

Simulated stress data of the rotating blade is then obtained under simulated use conditions (Step 214). Such simulated use conditions can be generated by a flex tester or a fatigue testing apparatus, such as fatigue testing apparatus 900 as shown in FIG. 10. The fatigue testing equipment includes a blade fixture 910, a blade sensor location 912 to detect ultimate blade failure, a blade tip grip 914, an oscillator displacement sensor (not shown), and an oscillator 916. The oscillator 916 oscillates applying a cyclical load onto the rotating blade 918 to which it is affixed via the blade tip grip 914. The fatigue testing apparatus 900 is specifically configured to fatigue test a rotating blade 918, however the testing equipment, its structure, and operation are well known in the art and a detailed explanation of them is not necessary for a complete understanding of the present invention. In operation, the fatigue testing apparatus 900 applies a fixed cyclic load for a fixed displacement to the rotating blade 918. The stresses on the rotating blade 918 are then determined based on the amount of deflection of the rotating blade 918 which can be correlated against a calibrated stress vs. deflection curve. Alternatively, the stresses on the rotating blade 918 can be determined by instrumenting the rotating blade 918 with a strain measuring device such as a strain gauge. Typically, one or more blades are evaluated under simulated use conditions to determine a statistical average and standard deviation for the number of cycles to failure for the blade.

The simulated stress data is obtained as the number of cycles to failure (also referred to as the maximum life of the rotating blade) of the rotating blade at a given stress load or stress range. The simulated stress data is then converted to a second data set (Step 216). The second data set can be the resulting stress versus number of cycles to failure data curve, also known as an S-N curve or a Wöhler curve. The S-N curve is a graph of the magnitude of a cyclical stress (S) against the logarithmic scale of cycles to failure (N). The first and second data sets are then evaluated to determine the fatigue life of the rotating blade (Step 218). This is accomplished by comparing the first and second data sets using Miner's Rule. That is, the number of cycles to failure is calculated by inverting the sum of the ratio of counts for common zero mean stresses to the maximum life at predetermined data ranges.

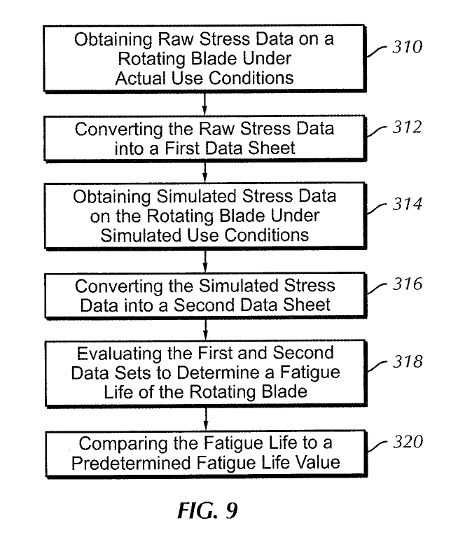

In another embodiment, the present invention provides for a method of evaluating rotating blades as shown in FIG. 9. That is, the present embodiment provides for a method of evaluating rotating blades to assess whether or not a given blade, such as from a production lot, a manufacturing run, a process validation, or an alternate vendor, meets a predetermined fatigue criteria without having to undergo subsequent testing under actual use conditions.

In this embodiment, raw stress data on the rotating blade is obtained under actual use conditions (step 310). The raw stress data is then converted into a first data set (step 312). Simulated stress data of the rotating blade is then obtained under simulated use conditions (Step 314). The simulated stress data is then converted to a second data set (Step 316). The first and second data sets are then evaluated to determine a fatigue life of the rotating blade (Step 318). Thereafter, the fatigue life is compared to a predetermined fatigue life acceptance criteria to assess if the rotating blade fatigue life meets the predetermined fatigue life value acceptance criteria (Step 320). For example, if the predetermined fatigue life acceptance criteria is 5,000 cycles, any determined value for the fatigue life over 5,000 cycles would satisfactorily meet the fatigue life acceptance criteria.

In practicing this embodiment, the raw stress data is typically obtained only once per blade design or geometry, as this is usually a very labor intensive and expensive process compared to collecting simulated stress data. As a result, the present method of evaluating rotating blades advantageously allows for the efficient and cost effective assessment of rotating blades derived from various production lots, manufacturing runs, validations, or various vendors to easily determine whether such rotating blades satisfactorily meets predetermined fatigue acceptance criteria without having to undergo timely and expensive testing under actual use conditions.

Fatigue theory applicable to the present invention are known in the art and a detailed explanation of the various methodologies is not necessary for a complete understanding of the invention. However, an exemplary fatigue theory includes the rainflow counting method (also known as the rainflow-counting algorithm). See Downing, S. D., Socie, D. F. Simple Rainflow Counting Algorithms. International Journal of Fatigue, Vol. 4, Issue 1, January, pgs. 31-40. (1982), the disclosure of which is hereby incorporated in relevant part by reference. The rainflow counting method is a well known technique used in the analysis of fatigue data in order to reduce a spectrum of varying stresses into a set of simple stress reversals. Its importance is that is allows the application of Miner's rule in order to assess the fatigue life of a structure subject to complex loading. See Fundamentals of Metal Fatigue Analysis, Bannatine, Comer, Handrock (1990) and Metal Fatigue in Engineering, Stephens, Fatemi, Stephens, Fuchs, 2^{nd} edition, the disclosures of which are incorporated in relevant part herein by reference.

The Miner's rule also known as the Palmgren-Miner linear damage hypothesis, states that where there are k different stress magnitudes in a spectrum, Sᵢ(1≦i≦k), (S=magnitude of a cyclical stress; N=number of cycles) each contributing nᵢ(Sᵢ) cycles, then if Nᵢ(Sᵢ) is the number of cycles to failure of a constant stress reversal Sᵢ, failure occurs when:

$${\sum }_{i = 1}^{k} \frac{{n}_{i}}{{N}_{i}} = C$$

Typically C is found to be between 0.7 and 2.2 through experimentation and is typically assumed to be 1 for general design purposes.

Basically, the Miner's rule assesses the proportion of fatigue life consumed by the stress reversals at each magnitude and then forms a linear combination of their aggregate.

The Goodman equation can also be used in conjunction with the rainflow counting method to make correlations of experimental fatigue data.

The following examples of the method of determining the blade fatigue life and of evaluating rotating blades will now be described by way of illustration and not by way of limitation.

### EXAMPLE I

The following is an example of the method for determining the fatigue life of a rotating blade as applied to a Blender Blade X.

A first Blender Blade X was subjected to cyclic loading on a blade flex testing deflection oscillator (i.e., a blade fatigue testing apparatus) similar to that illustrated in FIG. 9. The amount of deflection applied to Blender Blade X was used to determine the magnitude of stresses imparted onto Blender Blade X. To determine the range of stresses to apply to Blender Blade X for cyclic loading, the actual stresses observed under actual use conditions was preliminary assessed.

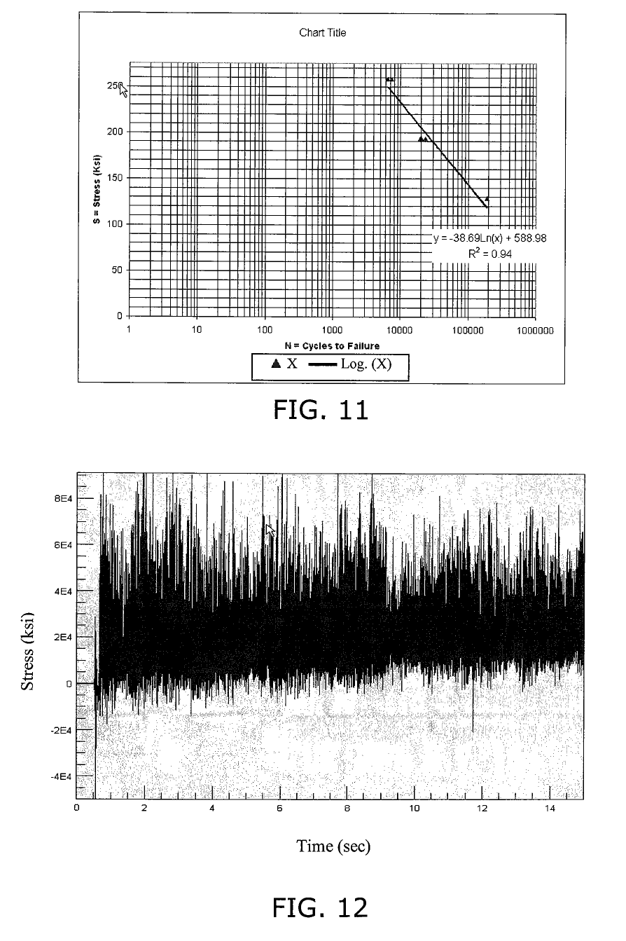

The stresses on Blender Blade X as a result of the cyclic loading was then plotted on a Stress versus Number of cycles (S-N) graph. The number of cycles N, represents the maximum number of cycles until fatigue failure, also referred to as the maximum life of the blade. An S-N curve was then developed based upon the measured stresses as illustrated in FIG. 11.

A second Blender Blade X was instrumented with a strain gauge apparatus. Blender Blade X was then subjected to actual use conditions to obtain raw stress data as shown in FIG. 12. FIG. 12 represents stresses measured on Blender Blade X as Blender Blade X was used to blend a pineapple mix consisting of 12 ounces of pineapple juice, 9 ounces of coconut cream, 3 ounces of milk cream, and 30 square ice tray cubes.

The resulting raw data measured for Blender Blade X during blending of the pineapple mix is illustrated in FIG. 12.

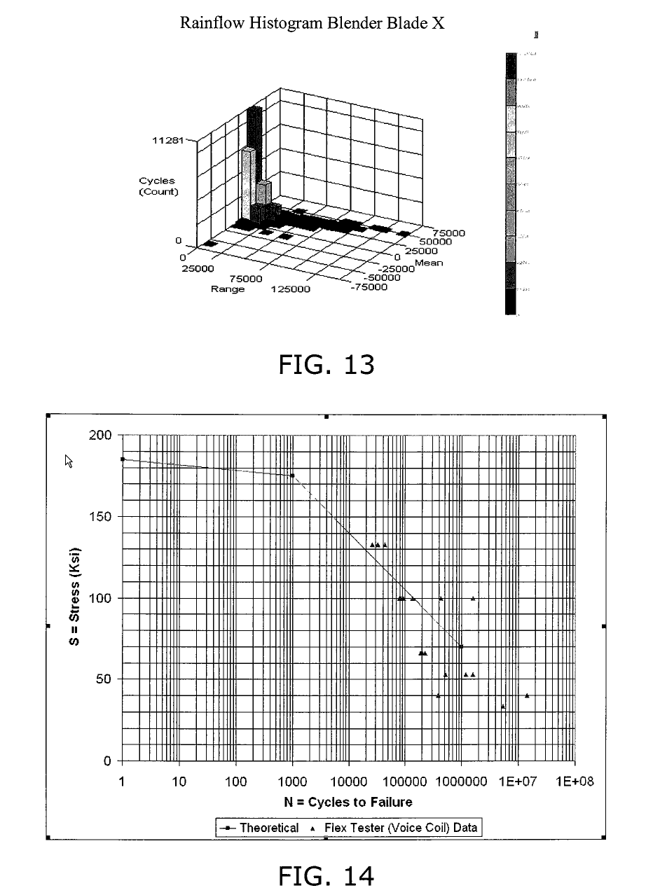

The raw stress data was then extracted using GlyphWorks software by nCode to generate a rainflow histogram. The rainflow histogram of the raw data is illustrated in FIG. 13. The rainflow histogram illustrates the alternating stress cycles measured on Blender Blade X. Table 1 is a tabular representation of the data in FIG. 13. Table 2 illustrates a normalized rainflow summation of non-zero mean counts to zero mean stress counts, i.e., the rain count (nᵢ) for discrete bins (i.e., stress ranges).

TABLE 1
Tabular representation of FIG. 13.

| | Alternating | | | | | | | |
|---|---|---|---|---|---|---|---|---|
| Amplitude | 2500 | 7500 | 12500 | 17500 | 22500 | 27500 | 32500 | 37500 |
| Range | 5000 | 15000 | 25000 | 35000 | 45000 | 55000 | 65000 | 75000 |

Mean ksi

| | | | | | | | | |
|---|---|---|---|---|---|---|---|---|
| 70000 | 0 | 0 | 0 | 0 | 0 | 0 | 0 | 0 |
| 60000 | 1 | 0 | 0 | 0 | 0 | 0 | 0 | 0 |
| 50000 | 4 | 0 | 0 | 1 | 0 | 0 | 0 | 0 |
| 40000 | 19 | 2 | 2 | 0 | 4 | 19 | 24 | 43 |
| 30000 | 137 | 45 | 180 | 357 | 321 | 240 | 117 | 39 |
| 20000 | 1.16E+04 | 3693 | 1549 | 599 | 172 | 39 | 5 | 0 |
| 10000 | 7536 | 1656 | 198 | 14 | 0 | 0 | 0 | 0 |
| 0 | 947 | 5 | 3 | 0 | 0 | 0 | 0 | 0 |
| −10000 | 54 | 2 | 0 | 1 | 0 | 1 | 0 | 0 |
| −20000 | 0 | 0 | 0 | 0 | 0 | 0 | 0 | 0 |
| −30000 | 0 | 0 | 0 | 0 | 0 | 0 | 0 | 0 |
| −40000 | 0 | 0 | 0 | 0 | 0 | 0 | 0 | 0 |
| −50000 | 0 | 0 | 0 | 0 | 0 | 0 | 0 | 0 |
| −60000 | 1 | 0 | 0 | 0 | 0 | 0 | 0 | 0 |
| −70000 | 0 | 0 | 0 | 0 | 0 | 0 | 0 | 0 |

| | Alternating | | | | | | |
|---|---|---|---|---|---|---|---|
| | | | | 57500 | 62500 | 67500 | 72500 |
| Amplitude | 42500 | 47500 | 52500 | 11500 | 12500 | 13500 | 14500 |
| Range | 85000 | 95000 | 105000 | 0 | 0 | 0 | 0 |
| Mean ksi | | | | | | | |
| 70000 | 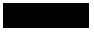 | 0 | 0 | 0 | 0 | 0 | 0 |
| 60000 | 0 | 0 | 0 | 0 | 0 | 0 | 0 |
| 50000 | 1 | 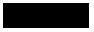 | 0 | 1 | 1 | 0 | 1 |
| 40000 | 16 | 11 | 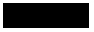 | 0 | 0 | 0 | 0 |
| 30000 | 7 | 4 | 0 | 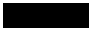 | 0 | 0 | 0 |
| 20000 | 0 | 0 | 0 | 0 | 0 | 0 | 0 |
| 10000 | 0 | 0 | 0 | 0 | 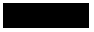 | 0 | 0 |
| 0 | 0 | 0 | 0 | 0 | 0 | 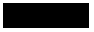 | 0 |
| −10000 | 0 | 0 | 0 | 0 | 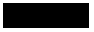 | 0 | 0 |
| −20000 | 0 | 0 | 0 | 0 | 0 | 0 | 0 |
| −30000 | 0 | 0 | 0 | 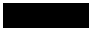 | 0 | 0 | 0 |
| −40000 | 0 | 0 | 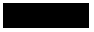 | 0 | 0 | 0 | 0 |
| −50000 | 0 | 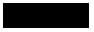 | 0 | 0 | 0 | 0 | 0 |
| −60000 | 0 | 0 | 0 | 0 | 0 | 0 | 0 |
| −70000 | 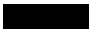 | 0 | 0 | 0 | 0 | 0 | 0 |

TABLE 2
Normalized rainflow summation table of non zero mean counts to zero
mean stress counts.

| alt bin | count |
|---|---|
| 0TO5 | 20339 |
| 5TO10 | 5403 |
| 10TO15 | 1930 |
| 15TO20 | 616 |
| 20TO25 | 358 |
| 25TO30 | 498 |
| 30TO35 | 279 |
| 35TO40 | 141 |
| 40TO45 | 63 |
| 45TO50 | 43 |
| 50TO55 | 23 |
| 55TO60 | 5 |
| 60TO65 | 11 |
| 65TO70 | 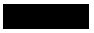 |
| 70TO75 | 0 |
| 75TO80 | 1 |
| 80TO85 | 0 |
| 85TO90 | 0 |
| 90TO95 | 0 |
| 95TO100 | 0 |
| 100TO105 | 0 |
| 105TO110 | 0 |
| 110TO115 | 0 |
| 115TO120 | 0 |
| 120TO125 | 0 |
| 125TO130 | 0 |
| 130TO135 | 0 |
| 135TO140 | 0 |
| 140TO145 | 0 |

Table 3 represents the zero mean stress equivalent of each discrete combination of mean and alternating stresses. The top row represents Alternating Stresses (Sₐ) while the left most column represents Mean Stresses (Sₘ). To calculate the fatigue stress with respective alternating stress/mean stress inputs, the Goodman equation was applied for each discrete combination (or bin).

Equation 1 represents the modified Goodman equation used for calculating the failure point of totally reversing constant loading and constant mean stresses.

$$\frac{{S}_{a}}{{S}_{Nf}} + \frac{{S}_{m}}{{S}_{u}} = 1. \qquad Equation 1$$

This relationship of mean and alternating stresses and material characteristics can be used to normalize data that has varying mean values as shown below.

Equation 2 represents the modified Goodman equation used to normalize non-zero mean rainflow data to zero mean data.

$${S}_{Nf} = \frac{{S}_{a}}{( 1 - \frac{{S}_{m}}{{S}_{u}} )} \\ \begin{matrix}Inputs \text{:} Alternating stress & {S}_{a} = 2 \text{,} 500 psi \\ Mean stress & {S}_{m} = 70 \text{,} 000 psi \\ Ultimate tensile & {S}_{u} = 185 \text{,} 000 psi\end{matrix} \\ {S}_{Nf} = \frac{{S}_{a}}{( 1 - \frac{{S}_{m}}{{S}_{u}} )} = \frac{2500}{( 1 - \frac{70000}{185000} )} = 4022 psi ( \begin{matrix}equivalent zero mean \\ stress fatigue stress .\end{matrix} ) . \qquad Equation 2$$

The resulting normalized zero mean stress values obtained for Blender Blade X is given in Table 3 below.

TABLE 3
Normalized stress values for given mean and alternating stresses.

| Alternating Stress, Sₐ | | | | | | | |
|---|---|---|---|---|---|---|---|
| 2500 | 7500 | 12500 | 17500 | 22500 | 27500 | 32500 | 37500 |

Mean Stress, Sₘ

| | | | | | | | | |
|---|---|---|---|---|---|---|---|---|
| 70000 | 4022 | 12065 | 20109 | 28152 | 36196 | 44239 | 52283 | 60326 |
| 60000 | 3700 | 11100 | 18500 | 25900 | 33300 | 40700 | 48100 | 55500 |
| 50000 | 3426 | 10278 | 17130 | 23981 | 30833 | 37685 | 44537 | 51389 |
| 40000 | 3190 | 9569 | 15948 | 22328 | 28707 | 35086 | 41466 | 47845 |
| 30000 | 2984 | 8952 | 14919 | 20887 | 26855 | 32823 | 38790 | 44758 |
| 20000 | 2803 | 8409 | 14015 | 19621 | 25227 | 30833 | 36439 | 42045 |
| 10000 | 2643 | 7929 | 13214 | 18500 | 23786 | 29071 | 34357 | 39643 |
| 0 | 2500 | 7500 | 12500 | 17500 | 22500 | 27500 | 32500 | 37500 |
| −10000 | 2643 | 7929 | 13214 | 18500 | 23786 | 29071 | 34357 | 39643 |
| −20000 | 2803 | 8409 | 14015 | 19621 | 25227 | 30833 | 36439 | 42045 |
| −30000 | 2984 | 8952 | 14919 | 20887 | 26855 | 32823 | 38790 | 44758 |
| −40000 | 3190 | 9569 | 15948 | 22328 | 28707 | 35086 | 41466 | 47845 |
| −50000 | 3426 | 10278 | 17130 | 23981 | 30833 | 37685 | 44537 | 51389 |
| −60000 | 3700 | 11100 | 18500 | 25900 | 33300 | 40700 | 48100 | 55500 |
| −70000 | 4022 | 12065 | 20109 | 28152 | 36196 | 44239 | 52283 | 60326 |

| | Alternating Stress, Sₐ | | | | | | |
|---|---|---|---|---|---|---|---|
| | 42500 | 47500 | 52500 | 57500 | 62500 | 67500 | 72500 |
| Mean Stress, Sₘ | | | | | | | |
| 70000 | 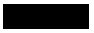 | 76413 | 84457 | 92500 | 100543 | 108587 | 116630 |
| 60000 | 62900 | 70300 | 77700 | 85100 | 92500 | 99900 | 107300 |
| 50000 | 58241 | 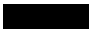 | 71944 | 78796 | 85648 | 92500 | 99352 |
| 40000 | 54224 | 60603 | 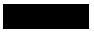 | 73362 | 79741 | 86121 | 92500 |
| 30000 | 50726 | 56694 | 62661 | 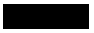 | 74597 | 80565 | 86532 |
| 20000 | 47652 | 53258 | 58864 | 64470 | 70076 | 75682 | 81288 |
| 10000 | 44929 | 50214 | 55500 | 60786 | 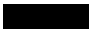 | 71357 | 76643 |
| 0 | 42500 | 47500 | 52500 | 57500 | 62500 | 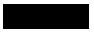 | 72500 |
| −10000 | 44929 | 50214 | 55500 | 60786 | 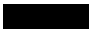 | 71357 | 76643 |
| −20000 | 47652 | 53258 | 58864 | 64470 | 70076 | 75682 | 81288 |
| −30000 | 50726 | 56694 | 62661 | 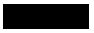 | 74597 | 80565 | 86532 |
| −40000 | 54224 | 60603 | 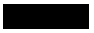 | 73362 | 79741 | 86121 | 92500 |
| −50000 | 58241 | 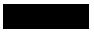 | 71944 | 78796 | 85648 | 92500 | 99352 |
| −60000 | 62900 | 70300 | 77700 | 85100 | 92500 | 99900 | 107300 |
| −70000 | 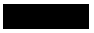 | 76413 | 84457 | 92500 | 100543 | 108587 | 116630 |

The cells or bins in Table 3 correspond to bins in Table 1. For any given normalized stress range, there are a group of bins in Table 3 that are included. For example, the stress range of 65 ksi to 70 ksi include all bins shaded on Table 3. These correspond to the shaded bins in Table 1. The sum of the shaded bins in Table 1 is the normalized rainflow count as shown in Table 2 as 65TO70. For this range there are only two non-zero bins, (Sₐ=47,500 ksi, Sₘ=50,000, count=1) and (Sₐ=52,500 ksi, Sₘ=40,000, count=6). The total cycle count for this stress range is 1+6=7 occurrences of normalized zero mean alternating stress.

Table 4 represents a comparison of the S-N curve and Normalized Rainflow summation of Blender Blade X. The table compares the maximum life of Blender Blade X when cycled at a constant stress level to the actual count of occurrences at the same stress level (i.e., stress ranges). Based on this data, the total damage to Blender Blade X is then calculated using Minor's Rule. The damage to Blender Blade X is the ratio of measured occurrences and maximum life. The reciprocal of the sum of the damages Dᵢ is the fatigue life of Blender Blade X.

TABLE 4
Calculation of blend cycles until failure.

| | |
|---|---|
| | Equation 3 |
| $D = \frac{{n}_{1}}{{N}_{1}} + \frac{{n}_{2}}{{N}_{2}} + \frac{{n}_{i}}{{N}_{i}} + … ( Miner ' s Rule Equation ) .$ | |

| Stress, ksi (Sᵢ) | Maximum life, Nᵢ for Sᵢ | Rain count, nᵢ | Damage, Dᵢ |
|---|---|---|---|
| 30TO35 | 1.20E+07 | 279 | 2.33E−05 |
| 35TO40 | 1.00E+07 | 141 | 1.41E−05 |
| 40TO45 | 9.00E+06 | 63 | 7.00E−06 |
| 45TO50 | 1.12E+06 | 43 | 3.83E−05 |
| 50TO55 | 9.86E+05 | 23 | 2.33E−05 |
| 55TO60 | 8.67E+05 | 5 | 5.77E−06 |
| 60TO65 | 7.61E+05 | 11 | 1.44E−05 |
| 65TO70 | 6.69E+05 | 7 | 1.05E−05 |
| 70TO75 | 5.88E+05 | 0 | 0.00E+00 |
| 75TO80 | 5.17E+05 | 1 | 1.94E−06 |
| 80TO85 | 4.54E+05 | 0 | 0.00E+00 |
| 85TO90 | 3.99E+05 | 0 | 0.00E+00 |
| 90TO95 | 3.51E+05 | 0 | 0.00E+00 |

| | |
|---|---|
| Cycles to failure (Σ 1/Dᵢ) | 7.21E+03 |

According to Blender Blade X's S-N curve, stress values below 30 ksi yielded infinite life results when tested, Nᵢ=∞. Therefore, they are not considered in the prediction calculation since the damage would be negligible.

The determined fatigue life of Blender Blade X is therefore 7,210 blend cycles.

### EXAMPLE II

The following is an example of the method for evaluating the fatigue life of a rotating blade as applied to a Blender Blade Y.

In this example, Blender Blade Y was evaluated to determine whether or not Blender Blade Y could satisfactorily meet a safety factor of 1.5 or greater. The safety factor is calculated by dividing the determined blade fatigue life by the maximum number of drinks estimated for Blender Blade Y. For Blender Blade Y, the maximum number drinks was estimated to be 5,500 drinks.

A first Blender Blade Y was subjected to cyclic loading on a blade flex testing deflection oscillator, similar to that of Blender Blade X in Example I. A resulting S-N graph was then plotted and an S-N curve developed based upon the measured stresses as illustrated in FIG. 14.

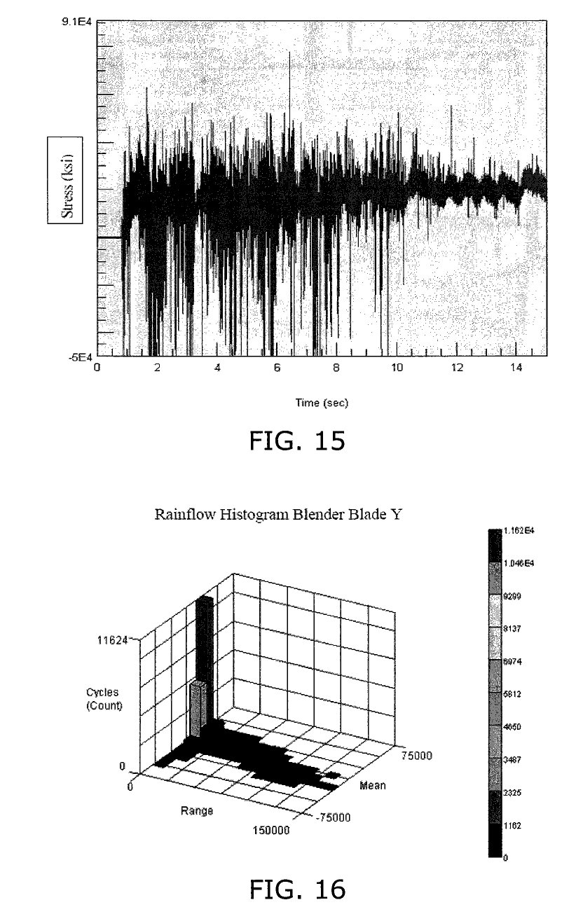

A second Blender Blade Y was then instrumented with a strain gauge apparatus. Blender Blade Y was then subjected to actual use conditions to obtain raw stress data as shown in FIG. 15. FIG. 15 represents stresses measured on Blender Blade Y as Blender Blade Y was used to blend a pineapple mix consisting of 12 ounces of pineapple juice, 9 ounces of coconut cream, 3 ounces of milk cream, and 30 square ice tray cubes.

The resulting raw data measured for Blender Blade Y during blending of the pineapple mix is illustrated in FIG. 15.

The raw stress data was then extracted using GylphWorks software by nCode to generate a rainflow histogram. The rainflow histogram of the raw data is illustrated in FIG. 16. The rainflow histogram illustrates the alternating stress cycles measured on Blender Blade Y. Table 5 is a tabular representation of the data in FIG. 16. Table 6 illustrates a normalized rainflow summation of non-zero mean counts to zero mean stress counts, i.e., the rain count (nᵢ) for discrete bins (i.e., stress ranges).

TABLE 5
Tabular representation of FIG. 16.

| | Alternating | | | | | | | |
|---|---|---|---|---|---|---|---|---|
| Amplitude | 2500 | 7500 | 12500 | 17500 | 22500 | 27500 | 32500 | 37500 |
| Range | 5000 | 15000 | 25000 | 35000 | 45000 | 55000 | 65000 | 75000 |

Mean ksi

| | | | | | | | | |
|---|---|---|---|---|---|---|---|---|
| 70000 | 0 | 0 | 0 | 0 | 0 | 0 | 0 | 0 |
| 60000 | 0 | 0 | 0 | 0 | 0 | 0 | 0 | 0 |
| 50000 | 1 | 0 | 0 | 0 | 0 | 0 | 0 | 0 |
| 40000 | 6 | 0 | 0 | 0 | 0 | 0 | 0 | 0 |
| 30000 | 478 | 10 | 10 | 4 | 1 | 0 | 0 | 0 |
| 20000 | 1.27E+04 | 1146 | 343 | 106 | 32 | 4 | 1 | 1 |
| 10000 | 5030 | 1096 | 342 | 133 | 69 | 38 | 10 | 5 |
| 0 | 1335 | 56 | 29 | 29 | 33 | 37 | 36 | 21 |
| −10000 | 11 | 2 | 2 | 5 | 5 | 9 | 13 | 15 |
| −20000 | 2 | 2 | 0 | 0 | 0 | 0 | 1 | 3 |
| −30000 | 4 | 1 | 0 | 0 | 0 | 0 | 0 | 0 |
| −40000 | 3 | 0 | 0 | 0 | 0 | 0 | 0 | 0 |
| −50000 | 2 | 0 | 0 | 0 | 0 | 0 | 0 | 0 |
| −60000 | 0 | 0 | 0 | 0 | 0 | 0 | 0 | 0 |
| −70000 | 0 | 0 | 0 | 0 | 0 | 0 | 0 | 0 |

| Amplitude | 42500 | 47500 | 52500 | 57500 | 62500 | 67500 | 72500 |
|---|---|---|---|---|---|---|---|
| Range | 85000 | 95000 | 105000 | 115000 | 125000 | 135000 | 145000 |
| Mean ksi | | | | | | | |
| 70000 | 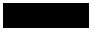 | 0 | 0 | 0 | 0 | 0 | 0 |
| 60000 | 0 | 0 | 0 | 0 | 0 | 0 | 0 |
| 50000 | 0 | 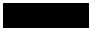 | 0 | 0 | 0 | 0 | 0 |
| 40000 | 0 | 0 | 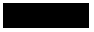 | 0 | 0 | 0 | 0 |
| 30000 | 0 | 0 | 0 | 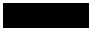 | 0 | 0 | 0 |
| 20000 | 0 | 0 | 0 | 0 | 0 | 0 | 0 |
| 10000 | 1 | 0 | 0 | 0 | 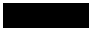 | 0 | 0 |
| 0 | 15 | 2 | 3 | 1 | 0 | 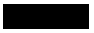 | 0 |
| −10000 | 14 | 8 | 11 | 4 | 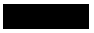 | 0 | 0 |
| −20000 | 3 | 1 | 2 | 1 | 1 | 1 | 1 |
| −30000 | 1 | 2 | 2 | 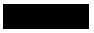 | 0 | 0 | 0 |
| −40000 | 0 | 0 | 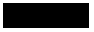 | 0 | 0 | 0 | 0 |
| −50000 | 0 | 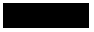 | 0 | 0 | 0 | 0 | 0 |
| −60000 | 0 | 0 | 0 | 0 | 0 | 0 | 0 |
| −70000 | 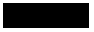 | 0 | 0 | 0 | 0 | 0 | 0 |

TABLE 6
Normalized rainflow summation table of non zero mean counts to zero
mean stress counts.

| alt bin | count |
|---|---|
| 0TO5 | 19602 |
| 5TO10 | 2313 |
| 10TO15 | 726 |
| 15TO20 | 273 |
| 20TO25 | 111 |
| 25TO30 | 117 |
| 30TO35 | 63 |
| 35TO40 | 43 |
| 40TO45 | 34 |
| 45TO50 | 5 |
| 50TO55 | 13 |
| 55TO60 | 16 |
| 60TO65 | 7 |
| 65TO70 | 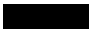 |
| 70TO75 | 1 |
| 75TO80 | 1 |
| 80TO85 | 0 |
| 85TO90 | 0 |
| 90TO95 | 0 |
| 95TO100 | 0 |
| 100TO105 | 0 |
| 105TO110 | 0 |
| 110TO115 | 0 |
| 115TO120 | 0 |
| 120TO125 | 0 |
| 125TO130 | 0 |
| 130TO135 | 0 |
| 135TO140 | 0 |
| 140TO145 | 0 |

Table 6 represents the zero mean stress equivalent of each discrete combination of mean and alternating stresses. The top row represents Alternating Stresses (Sₐ) while the left most column represents Mean Stresses (Sₘ). To calculate the fatigue stress with respective alternating stress/mean stress inputs, the Goodman equation was applied for each discrete combination (or bin).

Similar to Example I, a modified Goodman equation was used to normalize non-zero mean rainflow data to zero mean data with the following inputs for Blender Blade Y.

### Inputs:

Alternating stress Sₐ=2,500 psi

Mean stress Sₘ=70,000 psi

Ultimate tensile Sᵤ=185,000 psi

The resulting normalized zero mean stress values obtained for Blender Blade Y is given in Table 7 below.

TABLE 7
Normalized stress values for given mean and alternating stresses.

| Mean | | | | | | | | | | | | | | | |
|---|---|---|---|---|---|---|---|---|---|---|---|---|---|---|---|
| stress, | Alternating stress, Sₐ | | | | | | | | | | | | | | |
| Sₘ | 2500 | 7500 | 12500 | 17500 | 22500 | 27500 | 32500 | 37500 | 42500 | 47500 | 52500 | 57500 | 62500 | 67500 | 72500 |
| 70000 | 4022 | 12065 | 20109 | 28152 | 36196 | 44239 | 52283 | 60326 | 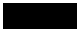 | 76413 | 84457 | 92500 | 100543 | 108587 | 116630 |
| 60000 | 3700 | 11100 | 18500 | 25900 | 33300 | 40700 | 48100 | 55500 | 62900 | 70300 | 77700 | 85100 | 92500 | 99900 | 107300 |
| 50000 | 3426 | 10278 | 17130 | 23981 | 30833 | 37685 | 44537 | 51389 | 58241 | 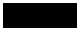 | 71944 | 78796 | 85648 | 92500 | 99352 |
| 40000 | 3190 | 9569 | 15948 | 22328 | 28707 | 35086 | 41466 | 47845 | 54224 | 60603 | 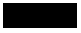 | 73362 | 79741 | 86121 | 92500 |
| 30000 | 2984 | 8952 | 14919 | 20887 | 26855 | 32823 | 38790 | 44758 | 50726 | 56694 | 62661 | 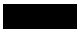 | 74597 | 80565 | 86532 |
| 20000 | 2803 | 8409 | 14015 | 19621 | 25227 | 30833 | 36439 | 42045 | 47652 | 53258 | 58864 | 64470 | 70076 | 75682 | 81288 |
| 10000 | 2643 | 7929 | 13214 | 18500 | 23786 | 29071 | 34357 | 39643 | 44929 | 50214 | 55500 | 60786 | 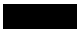 | 71357 | 76643 |
| 0 | 2500 | 7500 | 12500 | 17500 | 22500 | 27500 | 32500 | 37500 | 42500 | 47500 | 52500 | 57500 | 62500 | 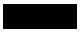 | 72500 |
| −10000 | 2643 | 7929 | 13214 | 18500 | 23786 | 29071 | 34357 | 39643 | 44929 | 50214 | 55500 | 60786 | 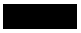 | 71357 | 76643 |
| −20000 | 2803 | 8409 | 14015 | 19621 | 25227 | 30833 | 36439 | 42045 | 47652 | 53258 | 58864 | 64470 | 70076 | 75682 | 81288 |
| −30000 | 2984 | 8952 | 14919 | 20887 | 26855 | 32823 | 38790 | 44758 | 50726 | 56694 | 62661 | 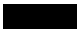 | 74597 | 80565 | 86532 |
| −40000 | 3190 | 9569 | 15948 | 22328 | 28707 | 35086 | 41466 | 47845 | 54224 | 60603 | 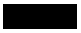 | 73362 | 79741 | 86121 | 92500 |
| −50000 | 3426 | 10278 | 17130 | 23981 | 30833 | 37685 | 44537 | 51389 | 58241 | 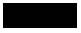 | 71944 | 78796 | 85648 | 92500 | 99352 |
| −60000 | 3700 | 11100 | 18500 | 25900 | 33300 | 40700 | 48100 | 55500 | 62900 | 70300 | 77700 | 85100 | 92500 | 99900 | 107300 |
| −70000 | 4022 | 12065 | 20109 | 28152 | 36196 | 44239 | 52283 | 60326 | 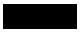 | 76413 | 84457 | 92500 | 100543 | 108587 | 116630 |

The cells and bins in Table 7 correspond to bins in Table 5. For any given normalized stress range, there are a group of bins in Table 7 that are included. For example, the stress range 65 ksi to 70 ksi include all bins shaded in Table 7. These correspond to the shaded bins in Table 5. The sum of the shaded bins in Table 5 is the normalized rainflow count as shown in Table 2 as 65TO70. For this range there are only three non-zero bins, (Sₐ=67,500 ksi, Sₘ=0, count=1), (Sₐ=52,500 ksi, Sₘ=−10,000, count=4), and (Sₐ=55,500 ksi, Sₘ=30,000, count=1). The total cycle count for this stress range is 1+4+1=6 occurrences of normalized zero mean alternating stress.

Table 8 represents a comparison of the S-N curve and Normalized Rainflow summation of Blender Blade Y. The table compares the maximum life of Blender Blade Y when cycled at a constant stress level to the actual count of occurrences at the same stress level (i.e., stress ranges). Based on this data, the total damage to Blender Blade Y is then calculated using Minor's Rule. The damage to Blender Blade Y is the ratio of measured occurrences and maximum life. The reciprocal of the sum of the damages Dᵢ is the fatigue life of Blender Blade Y.

TABLE 8
Calculations of blend cycles until failure.

| Stress, ksi (Sᵢ) | Maximum life, Nᵢ for Sᵢ | Rain count, nᵢ | Damage, Dᵢ |
|---|---|---|---|
| 50TO55 | 3.65E+05 | 13 | 3.56E−05 |
| 55TO60 | 3.18E+05 | 16 | 5.04E−06 |
| 60TO65 | 2.70E+05 | 7 | 2.59E−05 |
| 65TO70 | 2.35E+05 | 6 | 2.55E−05 |
| 70TO75 | 2.00E+05 | 1 | 4.99E+00 |
| 75TO80 | 1.74E+05 | 1 | 5.73E−06 |
| 80TO85 | 1.48E+05 | 0 | 0.00E+00 |

| | |
|---|---|
| Cycles to failure (Σ 1/Dᵢ) | 6.75E+03 |

According to Blender Blade Y's S-N curve, stress values below 50 ksi yielded infinite life results when tested, Nᵢ=∞. Therefore, they are not considered in the prediction calculation since the damage would be negligible.

The determined fatigue life of Blender Blade Y is therefore 6,750 blend cycles. As a result, the safety factor is 6,750/5,500=1.3. Therefore, Blender Blade Y does not satisfactorily meet a safety factor of 1.5.

It will be appreciated by those skilled in the art that changes could be made to the embodiments described above without departing from the broad inventive concept thereof. It is understood, therefore, that this invention is not limited to the particular embodiment disclosed, but it is intended to cover modifications within the spirit and scope of the present invention as defined by the appended claims.

We claim:

1. A strain gauge apparatus for measuring stresses on a rotating blade comprising:
a strain gauge assembly that includes:
a strain gauge for measuring strain on a rotating blade, and
lead wires connected to the strain gauge;
a shaft connected to the rotating blade; and
a slip ring connected to the shaft and the lead wires.

2. The strain gauge apparatus of claim 1, wherein the strain gauge is secured to the rotating blade.

3. The strain gauge apparatus of claim 1, wherein the strain gauge is covered.

4. The strain gauge apparatus of claim 1, further comprising a sleeve covering at least a portion of the lead wires.

5. The strain gauge apparatus of claim 4, wherein the sleeve is an annular sleeve or a flexible wrap.

6. The strain gauge apparatus of claim 1, further comprising a data acquisition system in communication with the strain gauge.

7. The strain gauge apparatus of claim 1, wherein the rotating blade is a blender blade, a food processing blade, a mixing blade, a turbine blade, a propeller blade, or a cutting blade.

8. A strain gauge apparatus for measuring stresses on a blender blade mounted within a blender, comprising:
a strain gauge secured to a blender blade;
a shaft connected to the blender blade and extending through an upper portion of the blender;
lead wires connected to the strain gauge and routed along the shaft; and
a slip ring connected to the lead wires and the shaft at the upper portion of the blender.

9. The strain gauge apparatus of claim 8, further comprising a mounting structure engaged with the blender and the slip ring to secure the slip ring relative to the blender.

10. The strain gauge apparatus of claim 8, wherein the slip ring has a stationary portion and a rotating portion, the strain gauge apparatus further comprising:
a blender lid;
a mounting structure secured to the lid and the stationary portion; and
wherein the shaft is secured to the rotating portion.

11. The strain gauge apparatus of claim 8, further comprising a data acquisition system in communication with the strain gauge.

12. The strain gauge apparatus of claim 8, further comprising a sleeve covering at least a portion of the lead wires.

13. A method of measuring stresses on a rotating blade comprising the steps of:
securing a strain gauge having lead wires on a rotating blade mounted to a blade shaft;
connecting a shaft to the blade shaft for rotation therewith;
connecting a slip ring having slip ring wires to the shaft;
routing the lead wires along the shaft and connecting the lead wires to the slip ring; and
connecting the slip ring wires to a data acquisition system.

14. The method of claim 13, further comprising the step of covering the strain gauge with a coating.

15. The method of claim 13, further comprising the step of covering the lead wires.

16. A method of determining the fatigue life of a rotating blade comprising the steps of:
obtaining raw stress data on a rotating blade under actual use conditions;
converting the raw stress data into a first data set;
obtaining simulated stress data on the rotating blade under simulated use conditions;
converting the simulated stress data into a second data set; and
evaluating the first and second data sets to determine the fatigue life of the rotating blade.

17. The method of claim 16, wherein the step of converting the raw stress data comprises the steps of:
reducing the raw stress data to a rainflow histogram;
normalizing the rainflow histogram to an equivalent zero mean stress data set; and
grouping counts for common zero mean stress data ranges of the normalized equivalent zero mean stress data set.

18. The method of claim 16, wherein the second data set is a stress versus number of cycles to failure curve.

19. The method of claim 16, wherein the fatigue life is determined by applying the Palmgren-Miner linear damage hypothesis to the first and second data sets.

20. The method of claim 16, wherein the step of obtaining raw stress data comprises the steps of:
instrumenting the rotating blade with a strain gauge apparatus;
stressing the rotating blade under actual use conditions; and
measuring the stresses on the stressed rotating blade.

21. A method of evaluating rotating blades comprising the steps of:
obtaining raw stress data on a rotating blade under actual use conditions;
converting the raw stress data into a first data set;
obtaining simulated stress data on the rotating blade under simulated use conditions;
converting the simulated stress data into a second data set;
evaluating the first and second data sets to determine the fatigue life of the rotating blade; and
comparing the fatigue life to a predetermined fatigue life value.

22. The method of claim 21, wherein the step of converting the raw stress data comprises the steps of:
reducing the raw stress data to a rainflow histogram;
normalizing the rainflow histogram to an equivalent zero mean stress data set; and
grouping counts for common zero mean stress data ranges of the normalized equivalent zero mean stress data set.

23. The method of claim 21, wherein the second data set is a stress versus number of cycles to failure curve.

24. The method of claim 21, wherein the fatigue life is determined by applying the Palmgren-Miner linear damage hypothesis to the first and second data sets.

25. The method of claim 21, wherein the step of obtaining raw stress data comprises the steps of:
instrumenting the rotating blade with a strain gauge apparatus;
stressing the rotating blade under actual use conditions; and
measuring the stresses on the stressed rotating blade.
